(19) United States
(12) Patent Application Publication
(10) Pub. No.: US 2004/0117173 A1
(43) Pub. Date: Jun. 17, 2004

(54) Graphical feedback for semantic interpretation of text and images

(76) Inventors: Daniel Alexander Ford, Los Gatos, CA (US); Kristal Tiana Pollack, Simi Valley, CA (US)

Correspondence Address: ALISON D. MORTINGER, IBM CORPORATION, INTELLECTUAL PROPERTY LAW, 650 HARRY ROAD, DEPT. C4TA/J2B, San Jose, CA, 95120-6099, US

(21) Appl. No.: 10/323,042

(22) Filed: Dec. 18, 2002

(51) Int. Cl. G06F 17/27

(52) U.S. Cl. 704/9

(57) ABSTRACT

Indication of an interpreted meaning of a portion of a document by displaying an indication of the interpreted meaning near the document portion, where the portion may be text, nor non-text such as an image. The indication may be a symbol (without associated code) or an icon (with associated code to activate a specified function). Also included is disambiguation of a portion of a document, involving presenting indications of at least two alternative interpreted meanings of the document portion and displaying an indication of a selected interpreted meaning in response to one of the interpreted meanings being selected

### FIELD OF THE INVENTION

This invention relates to a visual interface for indicating the interpreted meaning of text and images, as well as for disambiguation of multiple meanings, and the underlying method for generating that interface.

### BACKGROUND

When a user enters text into a computer-based system, for example but not limited to an electronic calendar, to-do list, or word processing program, there are tools available to act on the input based upon the meaning of the text. For example, an active calendar (as described in U.S. Pat. No. 6,480,830 to Ford et al) can parse a calendar entry and automatically check airline flight availability, book conference rooms, notify attendees, etc. In order to perform these functions, it is essential that the calendar program interpret the meaning of the text entry correctly. An entry for “fly to CA” could indicate a flight to Canada, or a flight to California. So that the user correctly ends up in Saskatoon and not San Diego, the system should conveniently indicate to the user how the text has been interpreted as well as provide a way to choose between alternative meanings in the event that the system is unable to discern a unique meaning from context or other clues.

Other systems have been described that interpret text in one way or another but do not provide the desired functionality. One example is from U.S. Pat. No. 5,500,920 to Kupiec in which speech (or other non-machine ready format) is transcribed into a string of machine-ready symbols (such as letters, phones, or words) for the purpose of querying. The computer then performs disambiguation processing using text analysis and hypothesis testing. This system does not provide a visual feedback mechanism indicating meaning, nor a disambiguation method

Another example is described in U.S. Pat. No. 5,386,556 to Hedin, et al. Here, a natural language analyzer interprets text, however the result is a “logic form representation of the input” which includes textual indications of parts of speech, separate from the text itself.

In U.S. Pat. No. 5,960,384, a text parser designates words as “pictures” (i.e. nouns) or “relations” (i.e. adjectives or verbs) and displays them in a separate format (using boxes, parentheses), but again fails to provide a visual feedback mechanism indicating meaning or a disambiguation method.

Disambiguity in command processing by a robot is addressed in “Towards Seamless Integration in a Multimodal Interface” by Perzanowski et al, in the Proceedings of Workshop on Interactive Robotics in Entertainment, Carnegie Mellon University, June 2000, however the user is questioned by the robot for further information. No visual indications in conjunction with text are described.

Thus it would be desirable to have a visual feedback mechanism near the text to indicate the interpreted meaning of a portion of text (or an entire document) in order for the user to verify that the chosen meaning is correct. In addition, the mechanism can provide a means to disambiguate what was meant by the text.

### SUMMARY

A method for indicating an interpreted meaning of a portion of a document by displaying an indication of the interpreted meaning near the document portion is described. The portion may be text, nor non-text such as an image. The indication may be a symbol (without associated code) or an icon (with associated code to activate a specified function). A method for disambiguating a portion of a document is also described, involving presenting indications of at least two alternative interpreted meanings of the document portion and displaying an indication of a selected interpreted meaning in response to one of the interpreted meanings being selected.

For a fuller understanding of the nature and advantages of the present invention, reference should be made to the following detailed description taken together with the accompanying figures.

### BRIEF DESCRIPTION OF THE DRAWINGS

FIG. 1 shows an example of the visual feedback mechanism;

FIG. 2 shows the visual feedback mechanism applied to an image;

FIG. 3 shows the architecture of the system;

FIG. 4 shows the structure of the ontology; and

FIG. 5 shows a simplified example of entries in the Keyword/URL/Media Database from FIG. 3.

### EMBODIMENT

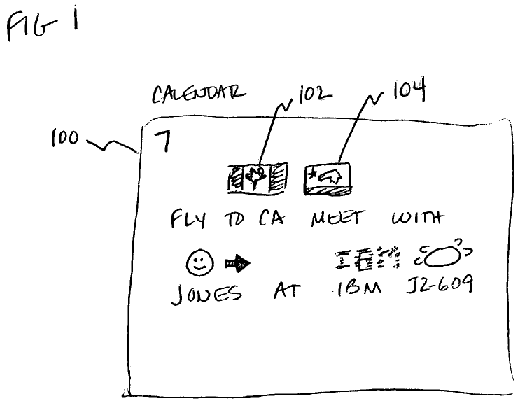

FIG. 1 shows an example of how the visual feedback mechanism works to indicate the meaning of interpreted text. It is a sample calendar entry 100 in which the user has typed “Fly to CA meet with Jones at IBM J2-609.” As the user types, the system will interpret the meaning of the text and display a symbol (without any associated code) or an icon (the selection of which activates associated code to perform a desired function) above or otherwise near to the text that it has interpreted. Note that the system can also be used to interpret text that has been previously created.

Here, the system has found two potential meanings for the term “CA”, notably Canada, indicated by the Canadian flag icon 102, or California, indicated by the California state flag icon 104. Note that the system has interpreted meanings for other words, like “IBM”, “Jones” and “J2-609” (a conference room). The interpreted meanings can be displayed in rank order according to the most likely interpretation based on context (such as surrounding text or other information on the display), or other factors such as ontology attributes (see below) or extrinsic text in e-mail, or web anchor text. If space on the display is at a premium, the system can simply indicate that more than one meaning is possible by using an indication such as an arrow or a plus sign alone or in combination with a single icon.

When the meaning of a term is ambiguous, i.e. there is more than one possible meaning that the system recognizes, the user simply chooses (with a suitable input device such as a mouse, pointer, touch screen, etc.) the correct icon, and the system will update the display. This update of one icon may cause a change in other icons as well, as the internal interpretation model is updated with each choice. For example, disambiguating Canada vs. California may change the interpretation of a listed city.

Alternately, user input may not be required if the system simply accepts the “first” listed interpretation of meaning in the absence of user input. This may be implemented for example when a user chooses a preferred interpretation for one text item in an entry but leaves the others as is, or indicates acceptance of an entire entry in a global manner without indicating individual interpretation acceptance. Such automatic disambiguation may be preferable in certain circumstances, for example where the system has “learned” over time what the user means when he or she enters specified text.

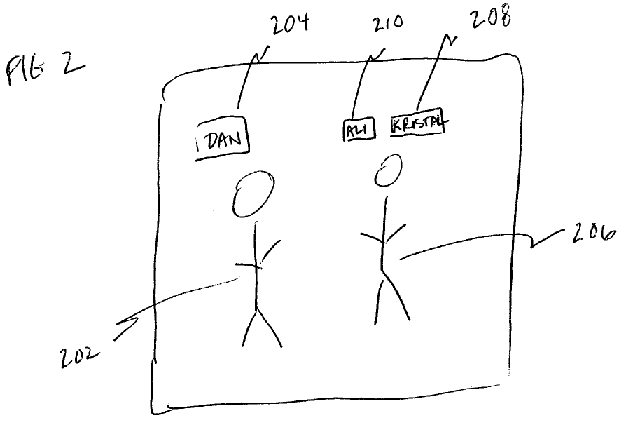

FIG. 2 shows another example in which the system can interpret images (in any discernible format such as JPEG, MPEG, TIFF, PDF, etc.) using any suitable image recognition software. Here, the image contains two individuals (admittedly crudely drawn), and the system interprets the “meaning” of the picture elements as two individuals 202 and 206. The system has interpreted individual 202 as “Dan”, and inserts an icon 204 nearby, and individual 206 as either “Kristal” or “Ali”, as indicated by icons 208 and 210. Note that the icons 208 and 210 can be active and can serve as links to Kristal and Ali's home pages. Browsing these pages may help identify who is really in the picture, and then the user can return to the image and choose the appropriate icon for disambiguation.

Another example of the use of the interpreter with images is the indication of objectionable content such as pornography. Here, a suitable content filter (for example the iMira Screening tool from Ulead Systems, Inc.) is used to detect objectionable content, and the system overlays an icon over the image. The icon may be overlaid such that a substantial part of the image cannot be seen. When selected, the icon could display warning text, or a link to a web form for filing a complaint with the Federal Communications Commission.

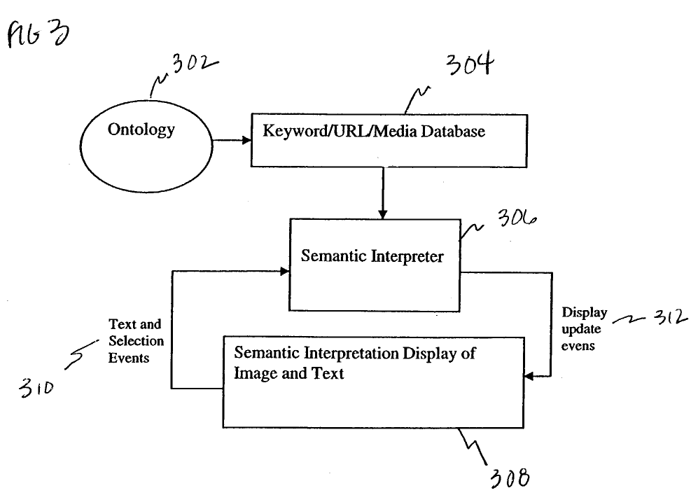

FIG. 3 shows the architecture of the system. The following explanation is focused on a textual interpretation rather than a graphic one, however the system applies to both. An ontology of world knowledge 302 is an organized set of data that creates a network of hierarchically organized concepts of people, places, things, and ideas. Ontology 302 is a data structure, e.g. a hierarchical or relational representation, expressed in textual form using a technology such as Resource Description Framework (RDF) serialized in extensible markup language (XML).

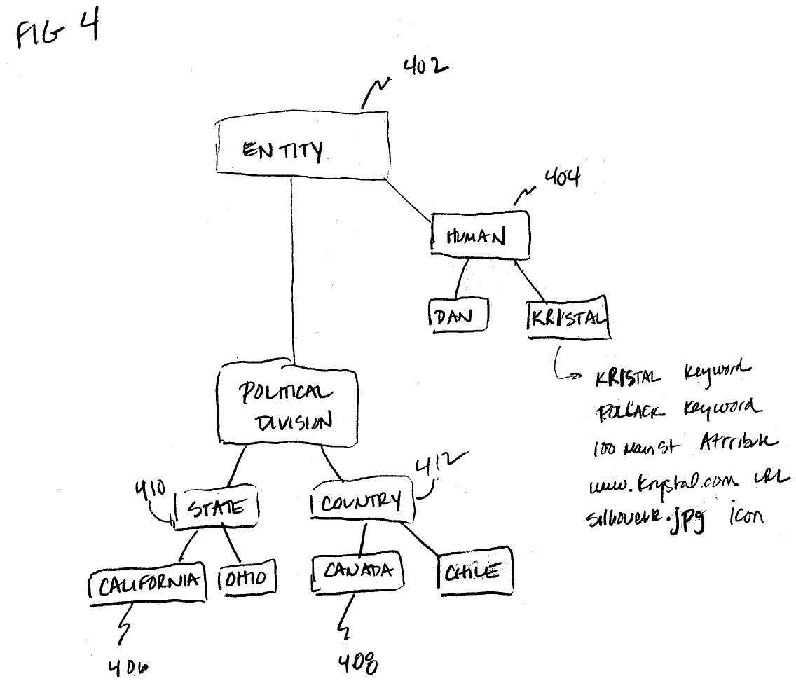

FIG. 4 shows the structure of ontology 302. The top entity in the ontology's hierarchy is an entity 402 which is defined to be a concept in the natural universe. Here, with a hierarchical representation, note that the top entity can be a root of a “tree” type representation as shown here, or it may be a node that has no parent in a directed acyclic graph (DAG). The rest of the entities in the ontology represent more refined sub-concepts that attempt to represent virtually anything that might be described in a document. Here, the entities for Dan and Kristal have “Human” 404 as a parent entity, with the links stored in the ontology. Likewise, entities California 406 and Canada 408 have parents 410 state and 412 country respectively which lead up to “political division,” a concept that we have defined to include man-made groups such as countries, states, etc. Note that the ontology contains at least one keyword for each entity, with a keyword being an identifier that might be used in a text document to refer to the entity. For instance, the entity “California” might have a keyword of “CA”, as would “Canada.” An entity may, and often will, have more than one keyword, and one keyword may represent more than one entry, thus there is a many to many relationship between entities and keywords. An entity may also have more than one parent.

Ontology 402 may also contain other attributes or data for each entry which may be examined by the interpreter (see below) in order to determine the best choice of entity for the interpretation. Examples of other attributes include URLs (pointing to various related real-world data sources), street addresses, personal profile information, icons, or other media files such as musical notes or audio tones (helpful when the system is being used by a visually impaired person). For more abstract entities such as the general idea of an airport, it might be an icon that describes all airports. For a specific airport, it could point to the airport's logo, if one is available. For the idea of a person, the associated icon could be a silhouette of a human figure, while the entry in the ontology for a specific individual might include a URL to their picture. An icon does not need to be explicitly specified for each entity in the ontology when a hierarchical representation is used for the ontology. If no icon is specified for an entity the icon associated with the parent of the entity will likely suffice, and can be easily located. For instance, in the previous example, if you divided people into personal and business contacts, but did not have specific icons for each of these, then the icon associated with the idea of a person could be used.

Returning to FIG. 3, entries in the ontology have associated entries in a Keyword/URL/Media database 304. Database 304 is populated by preprocessing the ontology to create an association between the keywords of an entity and its URL (if one is found). The technique used to represent the ontology makes it possible to associate a unique URL with each entry. This URL becomes the unique identifier for a particular person, place or thing. The entity's associated URL's for icons (and other media) become part of the database entry during preprocessing so they are retrieved along with the entity URL during any look up. Note that this URL is associated with where the entity is located in respect to the ontology, it is not a URL pointing to a website about the entity. This kind of URL would be a type of media.

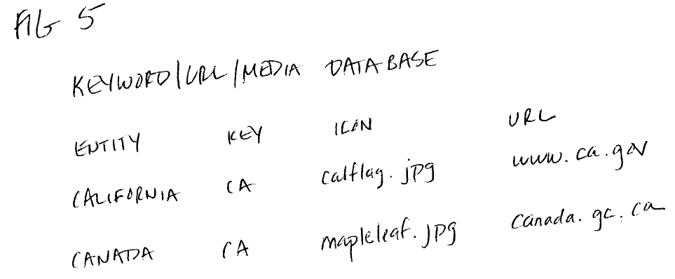

FIG. 5 shows a simplified example of two entries in the Keyword/URL/Media Database 304 from FIG. 3. In the earlier calendar example, a lookup of the keyword CA will bring up two entities, California 502 and Canada 504. California has an associated URL of www.ca.gov as well as a file calflagjpg containing the file (showing the state flag) used in constructing the icon for display. Likewise, Canada has canada.gc.ca, and the link for an icon to mapleleaf.jpg.

Returning again to FIG. 3, semantic interpreter 306 is responsible for creating associations between sequences of text and the URL's of entities in the ontology. It examines a sequence of words and then, as appropriate, creates collections of ontology URL's that, in its “opinion” are described by those words. It does this by using the words in the text as the source material for queries into the keyword/URL database 304. The results of those queries are processed by interpreter 306 and associated (i.e., stored) with the word(s) from the original sequence. If there is a single URL so associated, then the interpretation for the word is unique (but still possibly incorrect); if there is more than one URL, then the interpretation is ambiguous.

In either case, a user will have the opportunity to reject or refine the interpretation using the semantic interpretation display of image and text 308. This display represents the interface through which the user interacts with the system. It can allow the user to type text and to click a mouse or other pointing device to select items or regions. Display 308 and interpreter 306 interact through a series of “events”. The display generates text generation and pointer selection events 310, while the interpreter generates display events 312 that manipulate the positioning of text and images.

In operation, a user enters text (by typing, speaking, or other means of entry) in the display and the text is communicated to semantic interpreter 306 which may or may not decide it has an interpretation. When it does, interpreter 306 generates events that cause the display to draw icons intermixed with the text in a manner that clearly associates a particular icon or icons with a word or words of the text. For instance, in the calendar example, entering the word “Canada” results in a small Canadian flag icon appearing above the word “Canada”. Internally, the interpreter would associate the URL for the entity “Canada” (the country) with the word “Canada” (the text). In the case where there is more than one interpretation, the interpreter would create a rank order of what it thinks are the most likely interpretations and provides all of the appropriate icons (in rank order) to the display. These multiple icons and their rank can be displayed in more than one way. For example, with a limited amount of space, the most likely interpretations can be presented first (on the left) with the rest hidden behind an arrow (which indicates more icons), as shown in FIG. 1, with respect to the “Jones” text item.

The idea behind this approach is that a user would clearly see what interpretation was being made and that others were available. If he or she clicked on the “more” arrow they would see the other icons and would be able to reorder the interpretation rank by clicking on one of the other icons. These user actions would all be reported back to the interpreter 306 so that it could update its internal interpretation model. That might cause the interpreter to reevaluate some of its previous interpretations (e.g., if a user disambiguates a country name in a text document, the interpreter might then reevaluate the interpretation of the names of cities because they might be more likely to be in the identified country).

In this way, the text entered by a user would be reported to the interpreter which would then report back to the display the icons (and their order) that represent its interpretation. The user would see these icons and visually verify their associations with the text. If they agreed with the association (likely for a good interpreter and ontology), they need do nothing, if they disagree they could select alternative icons (and thus their interpretations) or if no correct icon/interpretation exists they could indicate that as well (perhaps by a “right click”). Alternatively, if the text is unable to be interpreted, the system may provide the opportunity for the user to directly enter a URL to provide the system with a starting point.

The final product of this process is the content of the internal model of the interpreter. The associations it has between URL's that point into the ontology 302 and the words in the text can be examined by other applications (such as e-commerce, for example) and processed as appropriate. Examples of other applications would be the automatic fetching of information associated with a calendar entry, or a software agent that books airplane tickets and other travel needs. Such applications are described in U.S. Pat. No. 6,480,830 to Ford et al titled Active Calendar

The logic of the present invention may be executed by a processor as a series of computer executable instructions. The instructions may be contained on any suitable data storage device with a computer accessible medium, such as but not limited to a computer diskette, CD ROM, or DVD having a computer usable medium with program code stored thereon, a DASD array, magnetic tape, conventional hard disk drive, electronic read only memory, or optical storage device.

In summary, a visual feedback mechanism near the text to indicate the interpreted meaning of a portion of text (or an entire document) in order for the user to verify that the chosen meaning is correct has been described. In addition, the mechanism can provide a means to disambiguate what was meant by the text.

While the present invention has been shown and particularly described with reference to the preferred embodiments, it will be understood by those skilled in the art that various changes in form and detail may be made without parting from the spirit and scope of the invention. Accordingly, the disclosed invention is to be considered merely illustrative and limited in scope only as specified in the following claims.

1. A method for indicating an interpreted meaning of a portion of a document, comprising displaying an indication of the interpreted meaning near the document portion.

2. The method of claim 1 wherein the portion is text.

3. The method of claim 2 wherein the indication is an icon with associated code to activate a specified function.

4. The method of claim 2 wherein the meaning is interpreted by looking up a keyword.

5. The method of claim 2 wherein the meaning is interpreted by examining context within the document.

6. The method of claim 2 wherein the meaning is interpreted by using words in the text as a source for queries into a database.

7. The method of claim 1 wherein the portion is an image.

8. The method of claim 7 wherein the indication of the interpreted meaning is overlaid on the image.

9. The method of claim 8 wherein the indication of the interpreted meaning is overlaid on the image so that a substantial part of the image cannot be seen.

10. The method of claim 1 wherein the indication is a symbol without any associated code.

11. The method of claim 1 wherein the indication is an icon with associated code to activate a specified function.

12. The method of claim 1 wherein the indication indicates that there is more than one possible meaning.

13. The method of claim 12 wherein the indication comprises at least one of an arrow and a plus sign.

14. The method of claim 12 wherein the possible meanings are ordered based on context within the document.

15. The method of claim 12 wherein the possible meanings are ordered based on related information external to the document.

16. The method of claim 1 wherein the document portion is interpreted as it is being created.

17. A method for disambiguating a portion of a document, comprising:
presenting indications of at least two alternative interpreted meanings of the document portion;
displaying an indication of a selected interpreted meaning in response to one of the interpreted meanings being selected.

18. The method of claim 17 wherein the selection is by a user choosing one of the indications by means of an input device.

19. The method of claim 18 wherein the selection is automatic.

20. The method of claim 19 wherein the selection is determined by accepting the first listed interpretation in the absence of user input.

21. The method of claim 17 wherein the disambiguation of the document portion causes the interpreted meaning of another portion of the document to be updated.

22. A program storage device accessible by a machine, tangibly embodying a program of instruction executable by the machine to perform the method step for indicating an interpreted meaning of a portion of a document, said method step comprising displaying an indication of the interpreted meaning near the document portion.

23. The method of claim 22 wherein the portion is text.

24. The method of claim 23 wherein the indication is an icon with associated code to activate a specified function.

25. The method of claim 23 wherein the meaning is interpreted by looking up a keyword.

26. The method of claim 23 wherein the meaning is interpreted by examining context within the document.

27. The method of claim 23 wherein the meaning is interpreted by using words in the text as a source for queries into a database.

28. The method of claim 22 wherein the portion is an image.

29. The method of claim 28 wherein the indication of the interpreted meaning is overlaid on the image.

30. The method of claim 29 wherein the indication of the interpreted meaning is overlaid on the image so that a substantial part of the image cannot be seen.

31. The method of claim 22 wherein the indication is a symbol without any associated code.

32. The method of claim 22 wherein the indication is an icon with associated code to activate a specified function.

33. The method of claim 22 wherein the indication indicates that there is more than one possible meaning.

34. The method of claim 33 wherein the indication comprises at least one of an arrow and a plus sign.

35. The method of claim 33 wherein the possible meanings are ordered based on context within the document.

36. The method of claim 33 wherein the possible meanings are ordered based on related information external to the document.

37. The method of claim 22 wherein the document portion is interpreted as it is being created.

38. A program storage device accessible by a machine, tangibly embodying a program of instruction executable by the machine to perform the method step for disambiguating a portion of a document, said method steps comprising:
presenting indications of at least two alternative interpreted meanings of the document portion;
displaying an indication of a selected interpreted meaning in response to one of the interpreted meanings being selected.

39. The method of claim 38 wherein the selection is by a user choosing one of the indications by means of an input device.

40. The method of claim 39 wherein the selection is automatic.

41. The method of claim 40 wherein the selection is determined by accepting the first listed interpretation in the absence of user input.

42. The method of claim 38 wherein the disambiguation of the document portion causes the interpreted meaning of another portion of the document to be updated.
